(19) United States
(12) Patent Application Publication
(10) Pub. No.: US 2002/0179663 A1
(43) Pub. Date: Dec. 5, 2002

(54) Retractable cargo area compartmentalizing device

(76) Inventors: Donal Moore, Birmingham, MI (US); Brian Bateman, Rochester Hills, MI (US)

Correspondence Address: Andrew R. Basile, Young & Basile, P.C., 3001 West Big Beaver Road, Suite 624, Troy, MI, 48084, US

(21) Appl. No.: 09/870,848

(22) Filed: May 31, 2001

(51) Int. Cl. B60R 7/02; B60R 7/00

(52) U.S. Cl. 224/539; 224/542; 224/925

(57) ABSTRACT

A retractable device compartmentalizes a vehicle cargo area. The device may be incorporated directly into the floor of the cargo area, or the device may comprise a housing removably disposed on or within the cargo area floor. An interior cavity is defined within the housing. A panel is selectively movable between a closed position wherein the panel covers the cavity and comprises at least a portion of the cargo area floor, and an open position. While in the open position, the panel divides the cargo area into at least two compartments. An optional partition is disposed within the housing and is selectively movable between an operative position and a storage position. A mechanism is provided for retracting the at least one partition into the cavity to the storage position. While in the operative position, the at least one partition divides the cargo area into at least two compartments.

### BACKGROUND OF THE INVENTION

The present invention relates generally to compartmentalizing devices for storage, and, more particularly, to such a device which may be retractable.

Consumers continually seek more efficient, convenient and versatile ways to transport contents to be stowed in a vehicle, for example a motor vehicle such as a van, automobile trunk or four wheel drive off-the-road vehicle. Conventional means of stowage transport have consisted mainly in trunk space, beds of pick-up trucks, or the area behind the rear seats in a van. These means have served their purpose satisfactorily, however, several drawbacks exist.

One disadvantage of the examples cited above is that stowage is freely movable within the stowage compartment, and can be damaged in the event of a sudden stop. Further, conventional stowage transporting means generally have only one large compartment, and it is difficult to transport a mixture of heavy items with more delicate or fragile items.

U.S. Pat. No. 6,015,071 discloses a compartmentalizing device. The '071 apparatus has two panels 22, 24 forming the floor of the trunk and in opposing position when raised. There are drawbacks associated with this apparatus. The '071 compartmentalizing device is rather complex and difficult to assemble. Further, it is not robust for nonconforming uses, e.g. if a cargo item larger than the individual compartments is placed into the device, it will destroy and/or damage the device.

Thus, it is an object of the present invention to provide a compartmentalizing device which has facile and/or intuitive deployment. Further, it is an object of the present invention to provide such a device which is easy to store. It is a further object of the present invention to provide such a device which is versatile and may provide a variety of variously sized compartments, as desired. It is a further object of the present invention to provide a device which can divide a single stowage transporting area into one or more discrete and sectioned areas within the stowage area. Yet further, it is an object of the present invention to provide such a device which is not sensitive to foreign objects, dirt, etc. for successful operation. It is another object of the present invention to provide such a device which may advantageously be substantially anti-rattle. Further, it is an object of the present invention to provide such a device which is advantageously partially or fully deployable. Yet still further, it is an object of the present invention to provide such a device which may be resilient and thus may be able to handle cargo of sizes larger than the size(s) of specific compartment(s).

### SUMMARY OF THE INVENTION

The present invention addresses and solves the above-mentioned problems and meets the enumerated objects and advantages, as well as others not enumerated, by providing a retractable device for compartmentalizing a cargo area having a floor. The device comprises a housing adapted to be removably disposed on the cargo area floor. An interior cavity is defined within the housing. A panel is selectively movable between a closed position wherein the panel covers the cavity and comprises at least a portion of the cargo area floor, and an open position. At least one partition is disposed within the housing and is selectively movable between an operative position and a storage position. Means, disposed within the housing, are provided for retracting the at least one partition into the cavity to the storage position. While in the operative position, the at least one partition divides the cargo area into at least two compartments.

### BRIEF DESCRIPTION OF THE DRAWINGS

Other objects, features and advantages of the present invention will become apparent by reference to the following detailed description and drawings, in which:

FIG. 1 is a cutaway perspective view of the retractable cargo area compartmentalizing device of the present invention, shown installed in the cargo area floor;

FIG. 2 is a partially broken away, cutaway perspective view showing one of the panels raised into the open position with two partitions installed;

FIG. 3 is an enlarged, cutaway perspective view showing the elastic cord receiving grommet;

FIG. 4 is an enlarged, cutaway cross sectional perspective view showing the attachment of the lower edge of the partition, and the bottom attachment of one of the side elastic cords, as well as the elastic cord receiving grommet and channel;

FIG. 5 is an enlarged, cutaway cross sectional perspective view showing the underside of the channel and grommet configuration shown in FIG. 4;

FIG. 6A is a partially schematic front view of 2 panels in the open position, showing the hooks extending from the living hinge, and showing the panels having widths proportioned in a 50:50 ratio;

FIG. 6B is a view similar to that of FIG. 6A, but showing the panels having widths proportioned in a 40:60 ratio;

FIG. 7 is an enlarged, cutaway perspective view showing the partition attached to the cargo area;

FIG. 8 is a view similar to that of FIG. 7, but showing an alternate means for attaching the partition to the cargo area;

FIG. 9 is an enlarged, cutaway, cross sectional perspective view showing the partition attached to the panel wall;

FIG. 10 is an enlarged cross sectional side view of the present invention, showing one panel raised to the open position, and a partition in the operative position, as well as a panel in phantom in a position intermediate the open and closed positions;

FIG. 11A is an enlarged, cutaway, partially schematic side view showing a panel in the open position, held within a groove;

FIG. 11B is an enlarged cutaway cross sectional side view showing a panel in the open position, with a pin protruding from the panel edge and received within a pin receiving recess;

FIG. 11C is an enlarged cutaway perspective view showing a panel in the open position, with a key member protruding from the panel edge and adapted to be received within a key slot;

FIG. 12A is an enlarged, cutaway perspective view of a cord end showing a crimp thereon;

FIG. 12B is an enlarged, cutaway cross sectional view showing the crimp keeping the cord on the exterior of the cavity wall; and

FIG. 13 is a partially broken away, cutaway perspective view showing an alternate embodiment of the compartmentalizing device of the present invention, showing one set of the panels raised into the open position with two partitions installed.

### DETAILED DESCRIPTION OF THE PREFERRED EMBODIMENTS

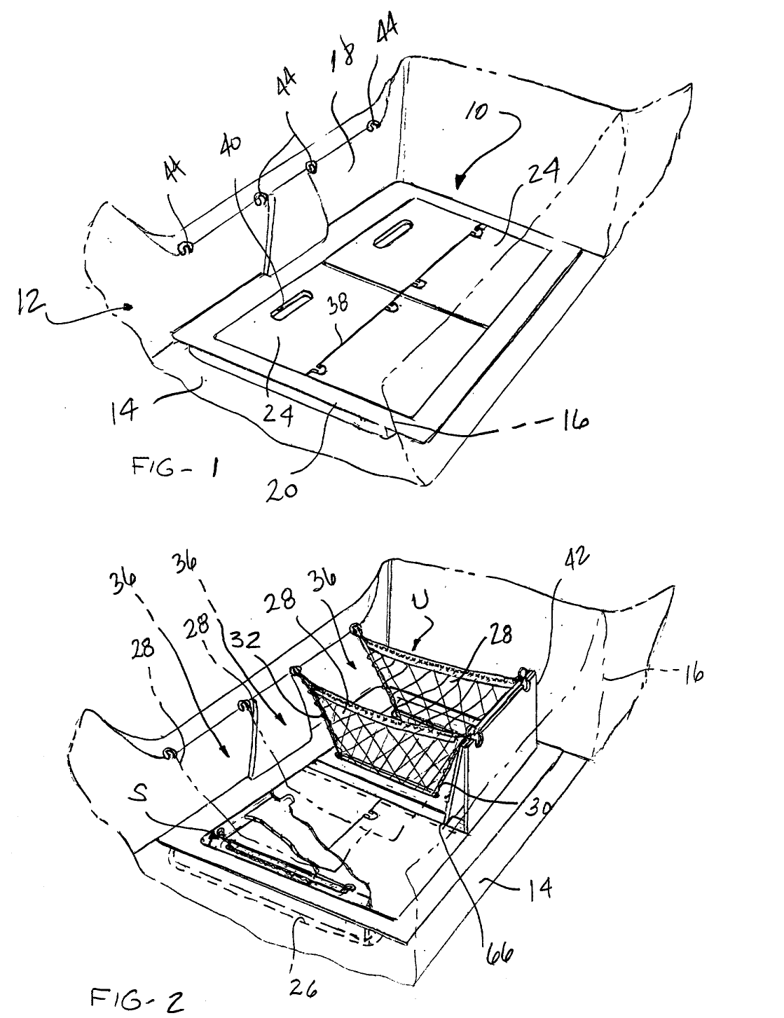

Referring now to FIG. 1, the retractable device of the present invention is designated generally as 10. It is to be understood that retractable device 10 may serve a variety of purposes and is not to be limited for use with automobiles only, nor is it to be limited for use within traditional “trunk” space(s) within automobiles. For example, device 10 may be suitable for use in air craft, boats, trailers, and pick up beds. However, retractable device 10 is particularly suitable for compartmentalizing a cargo area 12 in a vehicle, particularly a motor vehicle. Cargo area 12 has a floor 14, a front wall 16 and a rear wall 18.

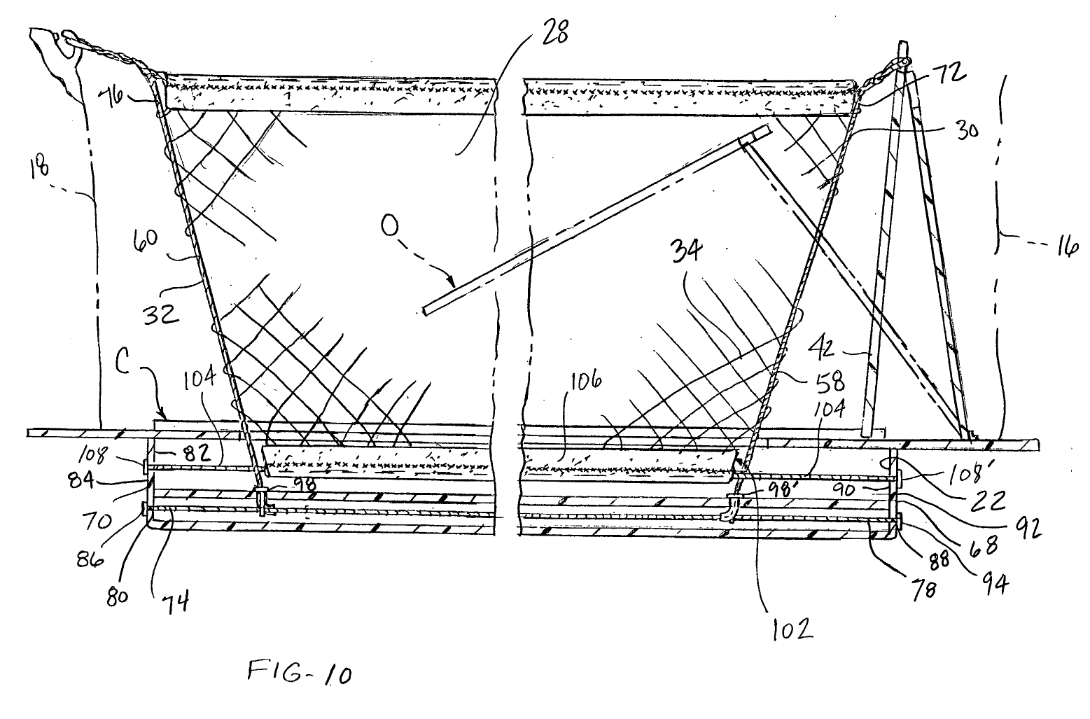

Retractable device 10 comprises a housing 20 adapted to be removably disposed on the cargo area floor 14. As best seen in FIG. 10, the housing 20 comprises an interior cavity 22 defined therewithin. It is to be understood that housing 20 may be formed by any suitable method and from any suitable material. Some examples of suitable methods include, but are not limited to blow molding, vacuum forming, injection molding, and the like. Some examples of suitable materials include, but are not limited to press board fiber, wood, polymeric materials selected from the group consisting of polypropylenes, glass reinforced polymers and/or resins (e.g. fiberglass), polyethylenes, acrylonitrile butadiene styrenes (ABS), and mixtures thereof, and the like. In the preferred embodiment, the method of choice is blow molding or vacuum forming, and the material of choice is a polypropylene based material.

As best seen in FIG. 2, the cargo area floor 14 may optionally have an opening 26 defined therein, the opening 26 adapted to receive at least a portion of the housing 20 therewithin. As can be seen, in the embodiment of FIG. 2, retractable device 10 is substantially flush with the cargo area floor 14.

The housing 20 may further comprise a panel 24 selectively movable between a closed position C wherein the panel 24 covers the cavity 22 and comprises at least a portion of the cargo area floor 14, and an open position O. The panel 24 may be formed in any suitable shape, size and/or configuration. However, in the preferred embodiment, the panel 24 includes a living hinge 38. Panel 24 may also optionally include any suitable means for grasping the panel 24, such as for example, a handle (not shown), a grasping slot 40, and the like. Panel 24 may be releasably locked into the open position O by any suitable means; however, in the preferred embodiment, panel 24 is releasably locked into position by panel edge 64 interengaged within groove 66.

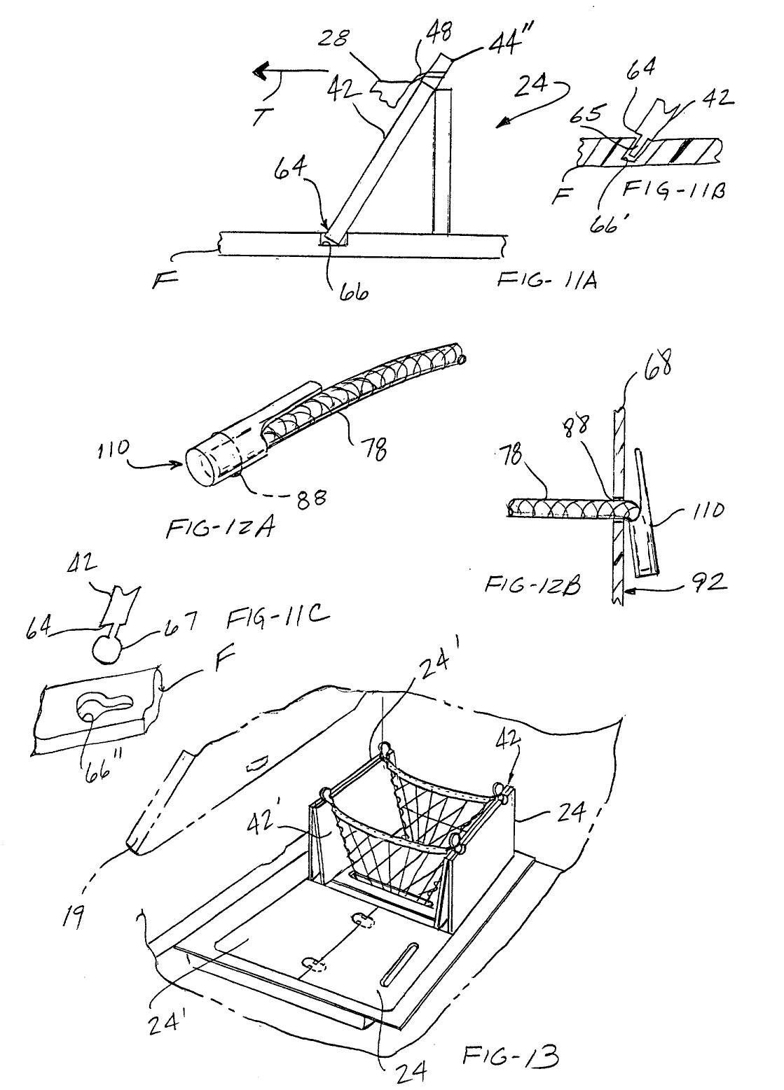

Referring now to FIG. 11A, loop 48 attached to cord 50 of partition 28 applies tension to wall 42 in the direction of arrow T. Without being bound to any theory, it is believed that this tension drives panel edge 64 substantially securely into groove 66 within floor F, thereby advantageously preventing panel edge 64 from disengaging from groove 66 until such disengagement is desired by the user.

It is to be understood that floor F may be an upper floor of device 10. Further, floor F may be the floor of the cargo area 12, e.g. device 10 may be incorporated directly into a vehicle's cargo area without a separate housing 20.

Further, it is to be understood that partition(s) 28 are optional. For example, without partition(s) 28, the panel(s) 24, 24′ and/or wall(s) 42 themselves may successfully and advantageously be used for cargo management.

FIGS. 11B and 11C depict two alternate embodiments for releasably retaining panel 24 in the open position O. The embodiments of FIGS. 11B and 11C may be particularly useful if partition(s) 28 are not used. FIG. 11B shows a pin 65 extending outwardly from panel edge 64. Pin 65 is releasably locked within pin receiving recess 66′ and generally remains within recess 66′ until removed by the consumer. FIG. 11C shows a key member 67 extending outwardly from panel edge 64. Key member 67 is releasably locked within key slot 66″ and generally remains within key slot 66″ until removed by the consumer.

When in the open position O, the panel 24 comprises a wall 42 adapted to be substantially vertical and adjacent at least one of the cargo area front wall 16 and cargo area rear area (e.g. rear wall 18 and/or lift gate 19). As can best be seen in FIG. 2, wall 42 is adjacent cargo area front wall 16.

As can best be seen in FIG. 13, an alternate embodiment of device 10 comprises at least one set of panels 24, 24′ (two sets 24, 24′ are shown in FIG. 13). In this embodiment, wall 42 is adjacent cargo area front wall 16; and wall 42′ is adjacent the cargo area rear area, specifically the lift gate 19. This alternate embodiment of device 10 may be particularly useful and/or desirable for vehicles having a lift gate 19 or a low rear wall 18.

The retractable compartmentalizing device 10 of the present invention may further optionally comprise at least one partition 28 disposed within the housing 20 and selectively movable between an operative position U and a storage and/or retracted position S, as best seen in FIG. 2. While in the operative position, the partition 28 divides the cargo area 12 into at least two compartments. The partition(s) 28 has a first opposed side 30 and a second opposed side 32. It is to be understood that the partition 28 may be formed from any suitable natural or synthetic material, including but not limited to netting material, woven materials, polymeric materials selected from the group consisting of polypropylenes, glass reinforced polymers and/or resins (e.g. fiberglass), polyethylenes, acrylonitrile butadiene styrenes (ABS), and mixtures thereof, woods, metallic materials, and the like.

In a preferred embodiment, the partition 28 is formed from a netting material 34. It is to be understood that netting material 34 may be formed by any suitable process, which processes include but are not limited to woven, knitted, rochelle, and weft insertion processes.

It is to be understood that there may be any number of partitions 28, as desired and/or necessitated by a particular end use. One exemplary embodiment is shown in FIG. 2, wherein there are four partitions 28 (two of which are shown in phantom in the operative position U). While in the operative position U, the four partitions 28 divide the cargo area 12 into at least three compartments 36.

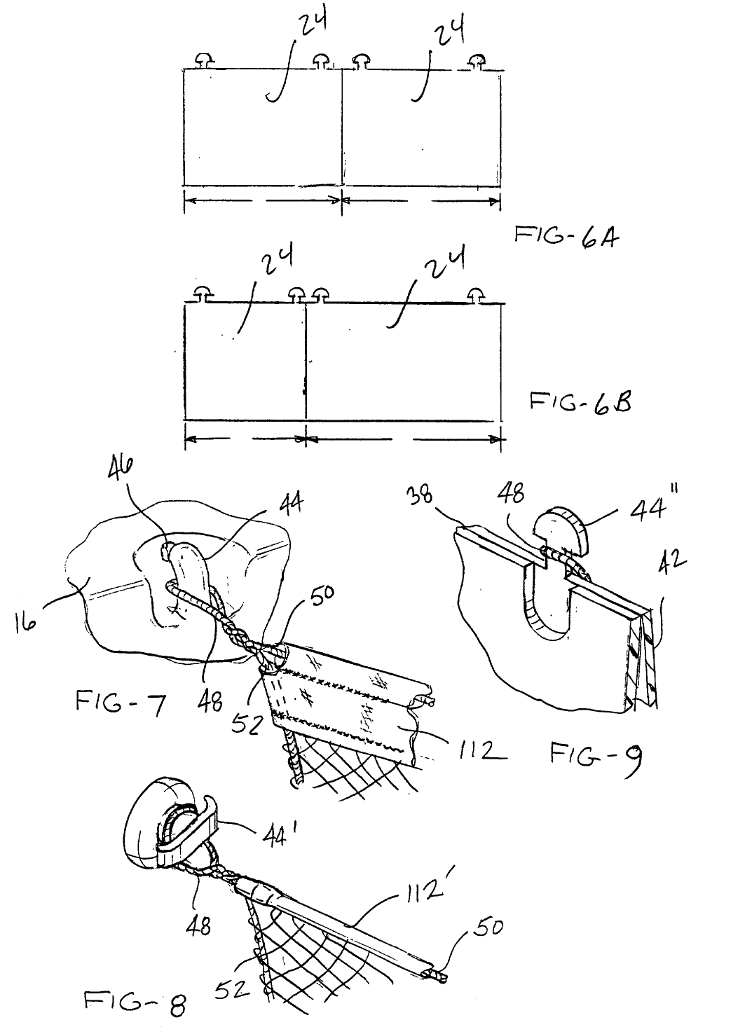

Means, disposed on at least one of the cargo area 12 and the housing 20, may be provided for removably attaching the partition(s) 28 in the operative position U. It is contemplated as being within the scope of the present invention to provide any suitable attaching means, such as for example, key members/key slots, snap fit assemblies, eyelet grommets/hook means, hook and loop (e.g. VELCRO) fasteners, and the like. However, in the preferred embodiment, the partition attaching means comprises at least one hook 44 disposed on one of the panel wall 42 and the partition(s) 28. It is to be understood that any suitable hook 44 and/or other releasably engageable fastener may be used as hook 44. Three exemplary embodiments of the hooks 44 are shown in FIGS. 7-9 and are designated 44, 44′ and 44″ . Hook 44 in FIG. 7 includes an optional nub 46 for substantially preventing inadvertent disengagement of the partition 28 from the hook 44.

The partition attaching means further comprises at least one loop 48 disposed on the other of the panel wall 42 and the partition 28. As can be seen in FIGS. 7 and 8, loop 48 is formed from elastic cord, such as bungee cord. Elastic cord 50 may be operatively connected to the top of partition 28 and terminate in an integral or attached loop 48 at each end. An elastic cord 52 may be operatively connected to each side of partition 28. Cords 50 and 52 may be separate, or they may comprise one cord as shown in FIGS. 7 and 8.

Further, cord 50 may optionally be in a sleeve 112 as shown in FIG. 7. Sleeve 112 may comprise any suitable material, such as a natural and/or synthetic cloth or webstrap. As shown in FIG. 8, optional sleeve 112′ may alternately be formed from a suitable, substantially rigid or semi-rigid material such as, for example, polymeric materials, metals (e.g. aluminum), and/or any other material as desired and/or necessitated by a particular end use/user.

Referring now to FIG. 9, living hinge 38 may comprise the panel wall upper edge 54, and hook 44″ extends outwardly from the panel wall upper edge 54. When panel 24 is in the closed position C, hook 44″ stores in slot 56. Loop 48 is disposed on partition 28 and releasably engages hook 44″.

The partition attaching means further comprises at least one hook 44 adapted to be disposed on one of: either the cargo area rear wall 18 or the cargo area front wall 16; and partition 28. The attaching means further comprises at least one loop 48 adapted to be disposed on the other of the cargo area rear wall 18/front wall 16; and the partition 28. As can be seen in FIG. 1, hooks 44 are disposed on cargo area rear wall 18. In an alternate embodiment as can be seen in FIG. 7, hook 44 is disposed on front wall 16.

Retractable compartmentalizing device 10 of the present invention further comprises means, disposed within the housing, for retracting the partition(s) 28 into the cavity 22 to the storage position S. It is to be understood that this retracting means may comprise any suitable means. For example, if cords 58 and 60 are not elastic, the retracting means may comprise spooling devices, spring mechanisms, draw cords, and the like.

In the preferred embodiment, the retracting means comprises a first elastic cord 58 attached to the first side 30; and a second elastic cord 60 attached to the second side 32 (as shown in FIG. 10). Upon detachment, partition 28 retracts into the cavity 22 through opening 62.

The cavity 22 has a front wall 68 adapted to be adjacent the cargo area front wall 16, and a rear wall 70 adapted to be adjacent the cargo area rear wall 18. The retracting means further comprises the first elastic cord 58 having a top end 72 adapted to be adjacent the cargo area front wall 16, and a bottom end 74 attached to the cavity rear wall 70. The second elastic cord 60 has a top end 76 adapted to be adjacent the cargo area rear wall 18, and a bottom end 78 attached to the cavity front wall 68. Means are provided for attaching each of the cord bottom ends 74, 78 to the respective cavity wall 70, 68.

It is to be understood that the cord bottom end attaching means may comprise any suitable means. However, in the preferred embodiment, this attaching means comprises a throughbore 80 defined in the cavity rear wall 70, extending from an interior surface 82 thereof to an exterior surface 84 thereof, wherein the first elastic cord bottom end 74 is receivable through the cavity rear wall throughbore 80. A first fastener 86 is provided for attaching the first elastic cord bottom end 74 to the exterior surface 84 of the cavity rear wall 70.

Cord bottom attaching means further comprises a throughbore 88 defined in the cavity front wall 68, extending from an interior surface 90 thereof to an exterior surface 92 thereof, wherein the second elastic cord bottom end 78 is receivable through the cavity front wall throughbore 88. A second fastener 94 is provided for attaching the second elastic cord bottom end 78 to the exterior surface 92 of the cavity front wall 68.

Each of the first 86 and second fasteners 94, as well as fasteners 108,108′ (discussed hereinbelow), may comprise any suitable fastener, such as for example key members/key slots and the like; however in a preferred embodiment, fasteners 86, 94,108,108′ each comprise a stop pin (as best seen in FIG. 4 and in hidden line in FIG. 5) attached to the respective elastic cord bottom ends 74, 78.

Referring now to FIGS. 12A and 12B, in a more preferred embodiment, each of fasteners 86, 94,108 and 108′ may comprise a crimp 110 attached to the respective end of the respective cord. As an example, crimp 110 is shown attached to cord end 78 and passing through throughbore 88 (in phantom) in FIG. 12A. After crimp 110 passes through the throughbore 88, crimp 110 rotates until it is substantially perpendicular to front wall 68 (see FIG. 12B). When cord end 78 is urged inward into the cavity 22, crimp 110 contacts the exterior surface 92 of wall 68 and acts as a stop to prevent cord end 78 from entering cavity 22. Further, it is believed apparent that the respective cord end may have crimp 110 (or any of the suitable fasteners discussed herein) attached to it after it extends through the respective throughbore to the exterior of cavity 22.

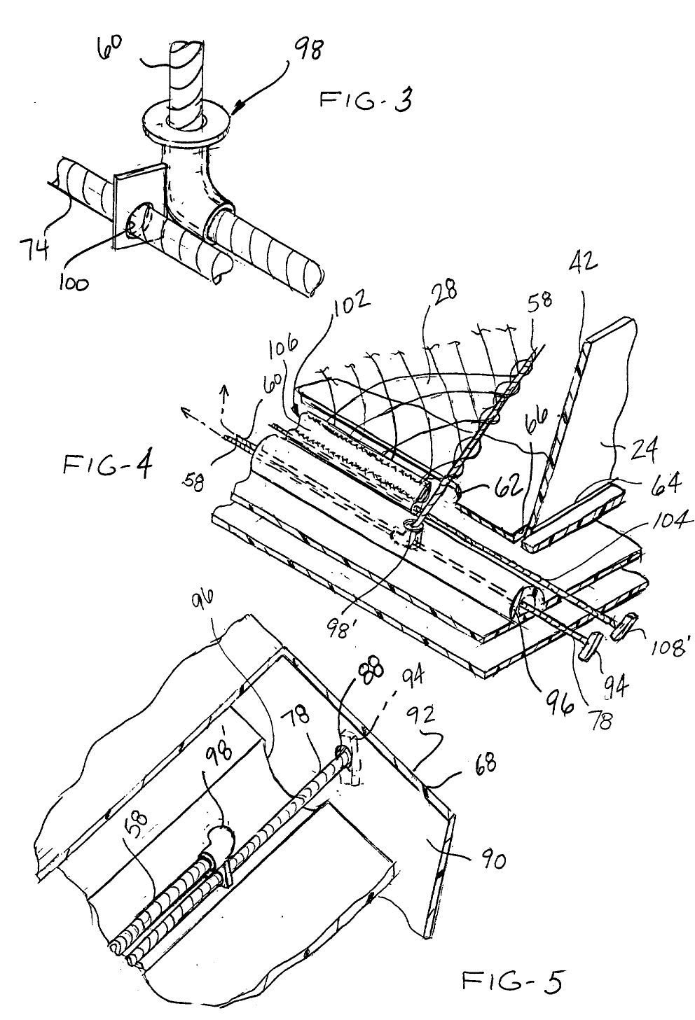

When sides 30, 32 are attached in the operative position U, the partition 28 is held taut in place. Immediately upon release from this attachment, the elastic cords 60, 58 having their respective bottom ends 78, 74 attached at the opposite cavity walls 68, 70 pull partition 28 down into opening 62. Cords 60, 58 run through grommets 98, 98′, which prevents chafing and/or erosion of the cords 60, 58. Grommets 98, 98′ may optionally include an aperture 100 (best seen in FIG. 3) for receiving the opposite side cord's bottom end. For example, FIG. 3 depicts grommet 98 receiving cord 60, and aperture 100 receives bottom end 74 of cord 58. Cords 58, 60 run within optional integrally formed channel 96 (shown in FIG. 4).

The lower edge 102 of partition 28 may be attached to the retractable device 10 by any suitable means, and this means may be a permanent, semi-permanent or releasable attachment means. In the preferred embodiment, partition 28 is attached to device 10 in the following manner. Elastic or non-elastic (preferably elastic) lower edge cord 104 runs through and/or is attached to lower edge 102 by any suitable means. As shown in FIG. 4, cord 104 may optionally run through a sleeve 106. Sleeve 106 may comprise any suitable material, such as a natural and/or synthetic cloth or webstrap. One end of cord 104 passes through a suitable throughbore in rear wall 70; and a fastener 108 is provided for attaching that end of the lower edge cord 104 to the exterior surface 84 of the cavity rear wall 70. In a similar manner, the other end of cord 104 passes through a suitable throughbore in front wall 68; and a fastener 108′ is provided for attaching that end of the lower edge cord 104 to the exterior surface 92 of the cavity front wall 68.

It is to be understood that there may be any number of panels 24, in any ratio. For example, as seen in FIG. 6A, the panels 24 have widths proportioned in a 50:50 ratio. In FIG. 6B, the panels 24 have widths proportioned in a 60:40 ratio. Further, the panels may have widths proportioned in a 70:30 ratio (not shown). Essentially, the panels 24 may be proportioned to fit the configuration of fold down seats in any vehicle, as desired.

While preferred embodiments, forms and arrangements of parts of the invention have been described in detail, it will be apparent to those skilled in the art that the disclosed embodiments may be modified. Therefore, the foregoing description is to be considered exemplary rather than limiting, and the true scope of the invention is that defined in the following claims.

What is claimed is:

1. A retractable device for compartmentalizing a cargo area having a floor, the device comprising:
a housing adapted to be removably disposed on the cargo area floor, the housing comprising:
an interior cavity defined within the housing; and
a panel selectively movable between a closed position wherein the panel covers the cavity and comprises at least a portion of the cargo area floor, and an open position;
wherein, while in the open position, the panel divides the cargo area into at least two compartments.

2. The retractable compartmentalizing device as defined in claim 1 wherein the device further comprises:
at least one partition disposed within the housing and selectively movable between an operative position and a storage position; and
means, disposed within the housing, for retracting the at least one partition into the cavity to the storage position;
wherein, while in the operative position, the at least one partition divides the cargo area into at least two compartments.

3. The retractable compartmentalizing device as defined in claim 1 wherein the panel comprises:
a living hinge; and
means for grasping the panel.

4. The retractable compartmentalizing device as defined in claim 2, further comprising means, disposed on at least one of the cargo area and the housing, for removably attaching the at least one partition in the operative position.

5. The retractable compartmentalizing device as defined in claim 4 wherein the at least one partition has a first opposed side and a second opposed side, and wherein the retracting means comprises:
a first elastic cord attached to the first side; and
a second elastic cord attached to the second side;
wherein, upon detachment, the at least one partition retracts into the cavity.

6. The retractable compartmentalizing device as defined in claim 5 wherein the cargo area has a front wall and a rear wall, wherein the cavity has a front wall adapted to be adjacent the cargo area front wall, and wherein the cavity has a rear wall adapted to be adjacent the cargo area rear wall, and wherein the retracting means further comprises:
the first elastic cord having a top end adapted to be adjacent the cargo area front wall, and a bottom end attached to the cavity rear wall;
the second elastic cord having a top end adapted to be adjacent the cargo area rear wall, and a bottom end attached to the cavity front wall; and
means for attaching each of the cord bottom ends to the respective cavity wall.

7. The retractable compartmentalizing device as defined in claim 6 wherein the cord bottom end attaching means comprises:
a throughbore defined in the cavity rear wall, extending from an interior surface thereof to an exterior surface thereof, wherein the first elastic cord bottom end is receivable through the cavity rear wall throughbore;
a first fastener for attaching the first elastic cord bottom end to the exterior surface of the cavity rear wall;
a throughbore defined in the cavity front wall, extending from an interior surface thereof to an exterior surface thereof, wherein the second elastic cord bottom end is receivable through the cavity front wall throughbore; and
a second fastener for attaching the second elastic cord bottom end to the exterior surface of the cavity front wall.

8. The retractable compartmentalizing device as defined in claim 7 wherein each of the first and second fasteners comprises a crimp attached to the respective elastic cord bottom end.

9. The retractable compartmentalizing device as defined in claim 1 wherein the cargo area floor has an opening defined therein, the opening adapted to receive at least a portion of the housing therewithin.

10. The retractable compartmentalizing device as defined in claim 1 wherein the device comprises two opposed panels, and wherein the cargo area has a front wall and a rear wall, and wherein, when in the open position, one opposed panel comprises a wall adapted to be substantially vertical and adjacent the cargo area front wall, and the other opposed panel comprises a wall adapted to be substantially vertical and adjacent the cargo area rear wall.

11. The retractable compartmentalizing device as defined in claim 4 wherein the cargo area has a front wall and a rear wall, and wherein, when in the open position, the panel comprises a wall adapted to be substantially vertical and adjacent at least one of the cargo area front wall and cargo area rear wall, wherein the partition attaching means comprises:
at least one hook disposed on one of the panel wall and the at least one partition; and
at least one loop disposed on the other of the panel wall and the at least one partition.

12. The retractable compartmentalizing device as defined in claim 11 wherein the panel wall is adapted to be adjacent the cargo area front wall, and wherein the partition attaching means further comprises:
at least one hook adapted to be disposed on one of the cargo area rear wall and the at least one partition; and
at least one loop adapted to be disposed on the other of the cargo area rear wall and the at least one partition.

13. The retractable compartmentalizing device as defined in claim 11 wherein the panel wall is adapted to be adjacent the cargo area rear wall, and wherein the partition attaching means further comprises:
at least one hook adapted to be disposed on one of the cargo area front wall and the at least one partition; and
at least one loop adapted to be disposed on the other of the cargo area front wall and the at least one partition.

14. The retractable compartmentalizing device as defined in claim 11 wherein the panel wall has an upper edge, wherein the panel has a living hinge which comprises the panel wall upper edge, and wherein the at least one hook extends outwardly from the panel wall upper edge, and the at least one loop is disposed on the at least one partition.

15. The retractable compartmentalizing device as defined in claim 2 wherein the at least one partition is formed from a netting material.

16. The retractable compartmentalizing device as defined in claim 15 wherein the netting material is formed by at least one of woven, knitted, rochelle, and weft insertion processes.

17. The retractable compartmentalizing device as defined in claim 2 wherein there are at least four partitions, wherein, while in the operative position, the at least four partitions divide the cargo area into at least three compartments.

18. The retractable compartmentalizing device as defined in claim 1 wherein there are two panels, the panels having widths proportioned in a 50:50 ratio.

19. The retractable compartmentalizing device as defined in claim 1 wherein there are two panels, the panels having widths proportioned in a 60:40 ratio.

20. The retractable compartmentalizing device as defined in claim 1 wherein there are two panels, the panels having widths proportioned in a 70:30 ratio.

21. A retractable device for compartmentalizing a motor vehicle cargo area having a floor, a front wall and a rear wall, the device comprising:
a housing adapted to be removably disposed on the cargo area floor, the housing comprising:
an interior cavity defined within the housing; and
a panel selectively movable between a closed position wherein the panel covers the cavity and comprises at least a portion of the cargo area floor, and an open position, wherein, when in the open position, the panel comprises a wall adapted to be substantially vertical and adjacent at least one of the cargo area front wall and cargo area rear wall, wherein the panel comprises:
a living hinge; and
means for grasping the panel;
at least one partition disposed within the housing and selectively movable between an operative position and a storage position;
means, disposed on at least one of the cargo area and the housing, for removably attaching the at least one partition in the operative position, wherein the partition attaching means:
at least one hook disposed on one of the panel wall and the at least one partition; and
at least one loop disposed on the other of the panel wall and the at least one partition; and
means, disposed within the housing, for retracting the at least one partition into the cavity to the storage position;
wherein, while in the operative position, the at least one partition divides the cargo area into at least two compartments.

22. The retractable compartmentalizing device as defined in claim 21 wherein the at least one partition has a first opposed side and a second opposed side, and wherein the retracting means comprises:
a first elastic cord attached to the first side; and
a second elastic cord attached to the second side;
wherein, upon detachment, the at least one partition retracts into the cavity.

23. The retractable compartmentalizing device as defined in claim 22 wherein the cargo area has a front wall and a rear wall, wherein the cavity has a front wall adapted to be adjacent the cargo area front wall, and wherein the cavity has a rear wall adapted to be adjacent the cargo area rear wall, and wherein the retracting means further comprises:
the first elastic cord having a top end adapted to be adjacent the cargo area front wall, and a bottom end attached to the cavity rear wall;
first means for attaching the first elastic cord bottom end to the cavity rear wall;
the second elastic cord having a top end adapted to be adjacent the cargo area rear wall, and a bottom end attached to the cavity front wall; and
second means for attaching the second elastic cord bottom end to the cavity front wall.

24. The retractable compartmentalizing device as defined in claim 23 wherein the first attaching means comprises:
a throughbore defined in the cavity rear wall, extending from an interior surface thereof to an exterior surface thereof, wherein the first elastic cord bottom end is receivable through the cavity rear wall throughbore;
a first fastener for attaching the first elastic cord bottom end to the exterior surface of the cavity rear wall;
a throughbore defined in the cavity front wall, extending from an interior surface thereof to an exterior surface thereof, wherein the second elastic cord bottom end is receivable through the cavity front wall throughbore; and
a second fastener for attaching the second elastic cord bottom end to the exterior surface of the cavity front wall.

25. The retractable compartmentalizing device as defined in claim 24 wherein each of the first and second fasteners comprises a crimp attached to the respective elastic cord bottom end.

26. The retractable compartmentalizing device as defined in claim 25 wherein the panel wall is adapted to be adjacent the cargo area front wall, and wherein the partition attaching means further comprises:
at least one hook adapted to be disposed on one of the cargo area rear wall and the at least one partition; and
at least one loop adapted to be disposed on the other of the cargo area rear wall and the at least one partition.

27. The retractable compartmentalizing device as defined in claim 25 wherein the panel wall is adapted to be adjacent the cargo area rear wall, and wherein the partition attaching means further comprises:
at least one hook adapted to be disposed on one of the cargo area front wall and the at least one partition; and
at least one loop adapted to be disposed on the other of the cargo area front wall and the at least one partition.

28. The retractable compartmentalizing device as defined in claim 25 wherein the panel wall has an upper edge, wherein the living hinge comprises the panel wall upper edge, and wherein the at least one hook extends outwardly from the panel wall upper edge, and the at least one loop is disposed on the at least one partition.

29. The retractable compartmentalizing device as defined in claim 21 wherein the at least one partition is formed from a netting material.

30. The retractable compartmentalizing device as defined in claim 29 wherein the netting material is formed by at least one of woven, knitted, rochelle, and weft insertion processes.

31. The retractable compartmentalizing device as defined in claim 21 wherein there are at least four partitions, wherein, while in the operative position, the at least four partitions divide the cargo area into at least three compartments.

32. The retractable compartmentalizing device as defined in claim 31 wherein there are two panels, the panels having widths proportioned in a 50:50 ratio.

33. The retractable compartmentalizing device as defined in claim 31 wherein there are two panels, the panels having widths proportioned in a 60:40 ratio.

34. The retractable compartmentalizing device as defined in claim 31 wherein there are two panels, the panels having widths proportioned in a 70:30 ratio.

35. The retractable compartmentalizing device as defined in claim 31 wherein there are two panels, and wherein the cargo area floor has an opening defined therein, the opening adapted to receive at least a portion of the housing therewithin.

36. A retractable device for compartmentalizing a cargo area having a floor, the device comprising:
an interior cavity defined within the cargo area; and
a panel selectively movable between a closed position wherein the panel covers the cavity and comprises at least a portion of the cargo area floor, and an open position;
wherein, while in the open position, the panel divides the cargo area into at least two compartments.

37. The retractable compartmentalizing device as defined in claim 36 wherein the device further comprises:
at least one partition disposed within the cargo area and selectively movable between an operative position and a storage position; and
means, disposed within the cargo area, for retracting the at least one partition into the cavity to the storage position;
wherein, while in the operative position, the at least one partition divides the cargo area into at least two compartments.

38. The retractable compartmentalizing device as defined in claim 36 wherein the panel comprises:
a living hinge; and
means for grasping the panel.

39. The retractable compartmentalizing device as defined in claim 37, further comprising means, disposed on at least one of the cargo area and the panel, for removably attaching the at least one partition in the operative position.

40. The retractable compartmentalizing device as defined in claim 39 wherein the at least one partition has a first opposed side and a second opposed side, and wherein the retracting means comprises:
a first elastic cord attached to the first side; and
a second elastic cord attached to the second side;
wherein, upon detachment, the at least one partition retracts into the cavity.

41. The retractable compartmentalizing device as defined in claim 40 wherein the cargo area has a front wall and a rear wall, wherein the cavity has a front wall adapted to be adjacent the cargo area front wall, and wherein the cavity has a rear wall adapted to be adjacent the cargo area rear wall, and wherein the retracting means further comprises:
the first elastic cord having a top end adapted to be adjacent the cargo area front wall, and a bottom end attached to the cavity rear wall;
the second elastic cord having a top end adapted to be adjacent the cargo area rear wall, and a bottom end attached to the cavity front wall; and
means for attaching each of the cord bottom ends to the respective cavity wall.

42. The retractable compartmentalizing device as defined in claim 41 wherein the cord bottom end attaching means comprises:
a throughbore defined in the cavity rear wall, extending from an interior surface thereof to an exterior surface thereof, wherein the first elastic cord bottom end is receivable through the cavity rear wall throughbore;
a first fastener for attaching the first elastic cord bottom end to the exterior surface of the cavity rear wall;
a throughbore defined in the cavity front wall, extending from an interior surface thereof to an exterior surface thereof, wherein the second elastic cord bottom end is receivable through the cavity front wall throughbore; and
a second fastener for attaching the second elastic cord bottom end to the exterior surface of the cavity front wall.

43. The retractable compartmentalizing device as defined in claim 42 wherein each of the first and second fasteners comprises a crimp attached to the respective elastic cord bottom end.

44. The retractable compartmentalizing device as defined in claim 36 wherein the device comprises two opposed panels, and wherein the cargo area has a front wall and a rear wall, and wherein, when in the open position, one opposed panel comprises a wall adapted to be substantially vertical and adjacent the cargo area front wall, and the other opposed panel comprises a wall adapted to be substantially vertical and adjacent the cargo area rear wall.

45. The retractable compartmentalizing device as defined in claim 39 wherein the cargo area has a front wall and a rear wall, and wherein, when in the open position, the panel comprises a wall adapted to be substantially vertical and adjacent at least one of the cargo area front wall and cargo area rear wall, wherein the partition attaching means comprises:
at least one hook disposed on one of the panel wall and the at least one partition; and
at least one loop disposed on the other of the panel wall and the at least one partition.

46. The retractable compartmentalizing device as defined in claim 45 wherein the panel wall is adapted to be adjacent the cargo area front wall, and wherein the partition attaching means further comprises:
at least one hook adapted to be disposed on one of the cargo area rear wall and the at least one partition; and
at least one loop adapted to be disposed on the other of the cargo area rear wall and the at least one partition.

47. The retractable compartmentalizing device as defined in claim 45 wherein the panel wall is adapted to be adjacent the cargo area rear wall, and wherein the partition attaching means further comprises:
at least one hook adapted to be disposed on one of the cargo area front wall and the at least one partition; and
at least one loop adapted to be disposed on the other of the cargo area front wall and the at least one partition.

48. The retractable compartmentalizing device as defined in claim 45 wherein the panel wall has an upper edge, wherein the panel has a living hinge which comprises the panel wall upper edge, and wherein the at least one hook extends outwardly from the panel wall upper edge, and the at least one loop is disposed on the at least one partition.

49. The retractable compartmentalizing device as defined in claim 37 wherein the at least one partition is formed from a netting material.

50. The retractable compartmentalizing device as defined in claim 49 wherein the netting material is formed by at least one of woven, knitted, rochelle, and weft insertion processes.

51. The retractable compartmentalizing device as defined in claim 37 wherein there are at least four partitions, wherein, while in the operative position, the at least four partitions divide the cargo area into at least three compartments.

52. The retractable compartmentalizing device as defined in claim 36 wherein there are two panels, the panels having widths proportioned in a 50:50 ratio.

53. The retractable compartmentalizing device as defined in claim 36 wherein there are two panels, the panels having widths proportioned in a 60:40 ratio.

54. The retractable compartmentalizing device as defined in claim 36 wherein there are two panels, the panels having widths proportioned in a 70:30 ratio.
